(19) United States
(12) Patent Application Publication
(10) Pub. No.: US 2005/0160207 A1
(43) Pub. Date: Jul. 21, 2005

(54) Computing apparatus including a hardware management add-on card

(75) Inventors: Chong-Kuang Chen, Taipei Hsien (TW); Wei-Tsung Wang, Taipei Hsien (TW); Tseng-Wen Chen, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Universal Scientific Industrial Co., Ltd.

(21) Appl. No.: 10/759,652

(22) Filed: Jan. 16, 2004

(51) Int. Cl. G06F 13/12

(52) U.S. Cl. 710/74; 710/301

(57) ABSTRACT

A computing apparatus includes a mainboard, a small outline dual in-line memory module (SO-DIMM) compliant slot, and a hardware management add-on card. The mainboard has electronic components mounted thereon. The SO-DIMM compliant slot is mounted on the mainboard and has a set of first electrical contacts coupled to the electronic components. The hardware management add-on card is mounted removably on the SO-DIMM compliant slot, has a set of second electrical contacts for connecting electrically with the first electrical contacts, and is operable so as to enable monitoring of the electronic components.

### BACKGROUND OF THE INVENTION

1. Field of the Invention

The invention relates to a computing apparatus, more particularly to a computing apparatus that includes a hardware management add-on card.

2. Description of the Related Art

A conventional server includes a server mainboard, a plurality of Peripheral Component Interface (PCI) slots, each of which is mounted on the mainboard, and an Intelligent Peripheral Management Interface (IPMI) compatible server management add-on card mounted removably on one of the PCI slots.

The server mainboard has electronic components, such as a central processing unit, south and north bridge chipsets, a network card, a sensor, an input/output (I/O) controller, and a fan, mounted thereon. Each of the PCI slots has a set of first electrical contacts coupled to the electronic components through a PCI bus.

The IPMI compatible server management add-on card has a set of second electrical contacts for connecting electrically with the first electrical contacts, and is operable so as to permit remote monitoring and control of the electronic components on the server mainboard. The set of second electrical contacts has a pin configuration that complies with the PCI specification.

The conventional server is disadvantageous in that, since the IPMI compatible server management add-on card is configured as a standard PCI add-on card, the IPMI compatible server management add-on card of the conventional server is relatively big and is required to occupy a PCI slot on the server mainboard, which reduces the availability of the server mainboard for connection to other PCI-compliant peripheral equipment.

### SUMMARY OF THE INVENTION

Therefore, the object of the present invention is to provide a computing apparatus that includes a non-PCI (Peripheral Component Interface) compliant hardware management add-on card.

According to the present invention, a computing apparatus comprises a mainboard, a small outline dual in-line memory module (SO-DIMM) compliant slot, and a hardware management add-on card. The mainboard has electronic components mounted thereon. The SO-DIMM compliant slot is mounted on the mainboard and has a set of first electrical contacts coupled to the electronic components. The hardware management add-on card is mounted on the SO-DIMM compliant slot, has a set of second electrical contacts for connecting electrically with the first electrical contacts, and is operable so as to enable monitoring of the electronic components.

### BRIEF DESCRIPTION OF THE DRAWING

Other features and advantages of the present invention will become apparent in the following detailed description of the preferred embodiment with reference to the accompanying drawing, of which:

FIG. 1 is a schematic circuit block diagram of the preferred embodiment of a computing apparatus according to the present invention.

### DETAILED DESCRIPTION OF THE PREFERRED EMBODIMENT

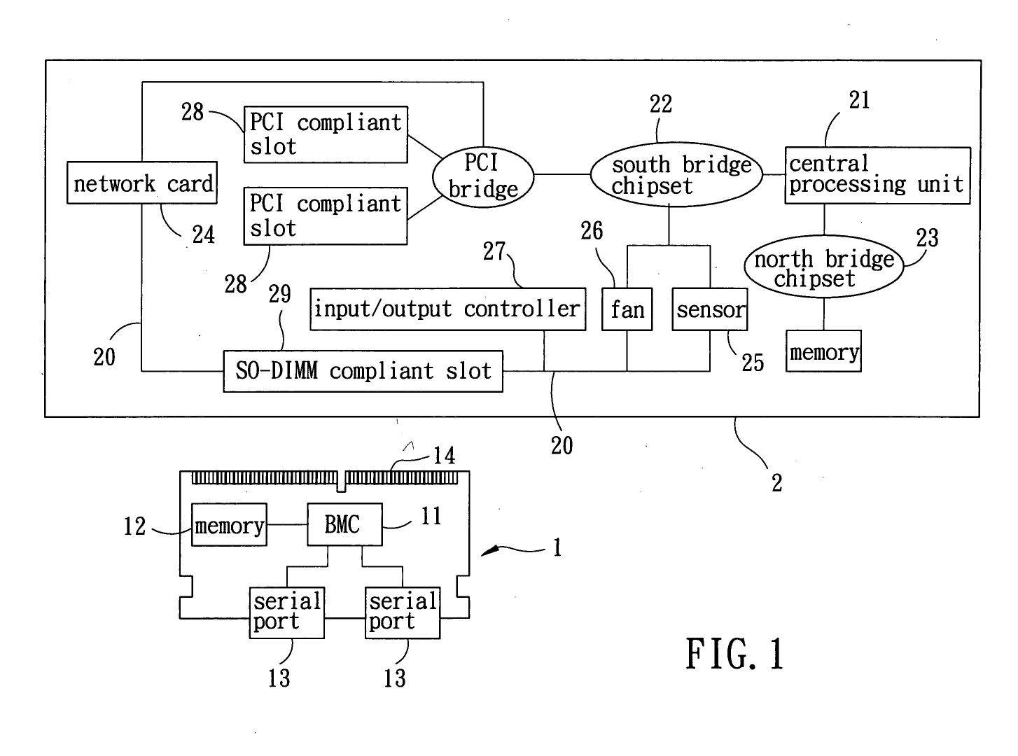

Referring to FIG. 1, the preferred embodiment of a computing apparatus according to the present invention is shown to be embodied in a server that includes a server mainboard 2, a small outline dual in-line memory module (SO-DIMM) compliant slot 29, and a hardware management add-on card 1.

The server mainboard 2 has a plurality of electronic components mounted thereon. The electronic components include a central processing unit 21, south and north bridge chipsets 22, 23, a network card 24, a sensor 25, an input/output (I/O) controller 27, and a fan 26. Peripheral Component Interface (PCI) slots 28 are also mounted on the mainboard 2.

The SO-DIMM compliant slot 29 is mounted on the server mainboard 2 and has a set of first electrical contacts (not shown) coupled to the electronic components through the I²C bus 20. It is noted that the SO-DIMM compliant slot 29 is not restricted to a particular physical location on the server mainboard 2, and is actually disposed at any appropriate position to fit in with the other electronic components on the server mainboard 2.

The hardware management add-on card 1 in this embodiment is an Intelligent Peripheral Management Interface (IPMI) compatible server management add-on card that is mounted removably on the SO-DIMM compliant slot 29, that has a set of second electrical contacts 14 for connecting electrically with the first electrical contacts, and that includes a baseboard management controller (BMC) 11, a memory 12 connected electrically to the BMC 11, and serial interface ports 13, each of which is connected electrically to the BMC 11. Each of the serial interface ports 13 is adapted for connecting electrically the hardware management add-on card 1 to an external peripheral device (not shown). Since the hardware management add-on card 1 is designed according to the SO-DIMM specification, the set of the second electrical contacts 14 of the hardware management add-on card 1 has a 144-pin configuration that complies with that of the SO-DIMM specification. As such, the size of the hardware management add-on card 1 in the present invention is not only smaller, the use of one of the PCI slots 28 on the server mainboard 2 is also spared.

It should be noted herein that, since monitoring and control of the electronic components through the hardware management add-on card 1 proceeds in a manner known to those skilled in the art, a detailed description of the same is dispensed with herein for the sake of brevity.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A computing apparatus, comprising:
a mainboard having at least an electronic component mounted thereon;
a small outline dual in-line memory module (SO-DIMM) compliant slot mounted on said mainboard and having a set of first electrical contacts coupled to said electronic component; and
a hardware management add-on card mounted on said SO-DIMM compliant slot and having a set of second electrical contacts for connecting electrically with said first electrical contacts, said hardware management add-on card being operable so as to enable monitoring of said electronic component.

2. The computing apparatus as claimed in claim 1, wherein said hardware management add-on card has a pin configuration that complies with that of a SO-DIMM specification.

3. The computing apparatus as claimed in claim 1, wherein said hardware management add-on card is further operable so as to enable control of said electronic component.

4. The computing apparatus as claimed in claim 1, wherein said mainboard is a server mainboard, and said hardware management add-on card is an Intelligent Platform Management Interface (IPMI) compatible server management add-on card.
